(19) United States
(12) Patent Application Publication
(10) Pub. No.: US 2025/0375965 A1
(43) Pub. Date: Dec. 11, 2025

(54) REPLACEMENT UNIT AND LIQUID EJECTION APPARATUS

(71) Applicant: Roland DG Corporation, Hamamatsu-shi (JP)

(72) Inventors: Hiroshi OKUNO, Hamamatsu-shi (JP); Ryosuke NONAKA, Hamamatsu-shi (JP); Akihiro SUZUKI, Hamamatsu-shi (JP); Akira SUWADA, Hamamatsu-shi (JP); Kazuki INO, Hamamatsu-shi (JP)

(21) Appl. No.: 19/217,023

(22) Filed: May 23, 2025

(30) Foreign Application Priority Data
Jun. 6, 2024 (JP) 2024-092262
Jun. 6, 2024 (JP) 2024-092263

(51) Int. Cl. B41J 2/165

(52) U.S. Cl. CPC B41J 2/16552; B41J 2/16508; B41J 2002/16558

(57) ABSTRACT

A replacement assembly is attachable/detachable to/from a liquid ejection apparatus including a head that is configured to eject a liquid. The replacement assembly includes a sheet to wipe a nozzle surface of the head, a supply roller configured to supply the sheet, a winding roller configured to wind the sheet, and a holding portion that holds the supply roller and the winding roller.

### CROSS REFERENCE TO RELATED APPLICATIONS

This application claims priority based on Japanese Patent Applications No. 2024-92262 and 2024-92263, both filed in Japan on Jun. 6, 2024, the contents of each of which are hereby incorporated herein by reference.

### BACKGROUND OF THE INVENTION

### 1. Field of the Invention

The present disclosure relates to replacement assemblies and liquid ejection apparatuses, each of the replacement assemblies being attachable/detachable to/from a liquid ejection apparatus.

### 2. Description of the Related Art

Japanese Patent Application Publication No. 2014-162135 discloses an apparatus that causes a sheet impregnated with a liquid to contact a head to wipe the head.

### SUMMARY OF THE INVENTION

In the case where a rotation shaft of a supply roller that supplies the sheet is not parallel with a rotation shaft of a winding roller that winds the sheet, a wrinkle may be formed in the sheet, or the sheet may be transported unevenly in a width direction. Thus, the rotation shaft of the supply roller and the rotation shaft of the winding roller need to be in parallel with each other. Meanwhile, in order to replace the sheet, the supply roller and the winding roller also need to be replaced. Thus, in replacing the sheet, the supply roller and the winding roller have to be installed in parallel with each other.

Example embodiments of the present disclosure facilitate work in replacing a sheet.

Incidentally, Japanese Patent Application Publication No. 2014-162135 discloses an apparatus that causes the sheet impregnated with the liquid to contact the head to wipe the head.

In a configuration disclosed in Japanese Patent Application Publication No. 2014-162135, the liquid has to be applied to a wide range of the sheet, resulting in a large amount of the liquid being consumed.

Example embodiments of the present disclosure reduce the amount of consumption of a liquid that is applied to a sheet. An example embodiment of the present disclosure is a replacement assembly attachable/detachable to/from a liquid ejection apparatus, the liquid ejection apparatus including a head that is configured to eject a liquid, the replacement assembly including a sheet to wipe a nozzle surface of the head, a supply roller configured to supply the sheet, a winding roller configured to wind the sheet, and a holding portion to hold the supply roller and the winding roller.

Another example embodiment of the present disclosure is a liquid ejection apparatus including a head that includes a nozzle surface in which a plurality of nozzle rows are positioned at predetermined intervals, a movable body configured to accommodate a sheet to wipe the nozzle surface, the movable body being movable with respect to a head, and an applicator configured to apply a cleaning solution to the sheet. The applicator includes a plurality of ejection ports configured to eject the cleaning solution toward the sheet, and the plurality of ejection ports are positioned at the predetermined intervals.

Other features of the present disclosure will become apparent from the description of the present specification.

According to example embodiments of the present disclosure, it is possible to facilitate work in replacing the sheet. In addition, according to example embodiments of the present disclosure, it is possible to reduce the amount of consumption of the liquid that is applied to the sheet.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic explanatory view of a liquid ejection apparatus 100 of an example embodiment of the present invention.

FIG. 2 is a block diagram of the liquid ejection apparatus 100.

FIG. 3 is an explanatory view of a nozzle surface 10A of a head 10 of an example embodiment of the present invention.

FIG. 4 is a perspective view of a wiper assembly 41 of an example embodiment of the present invention.

FIG. 5 is an explanatory view of a state where a cover 77 of an example embodiment of the present invention is opened.

FIG. 6 is an explanatory view of a state where a replacement assembly 80 is taken out from a movable body 70 of an example embodiment of the present invention.

FIG. 7 is a schematic explanatory view of a wiper assembly 41 of an example embodiment of the present invention.

FIGS. 8A to 8D are schematic explanatory views of a wiping process performed by the wiper assembly 41.

FIG. 9 is an explanatory view of positional relationships between ejection ports 62B of an applicator 62 and nozzle rows 11 of a head 10 of an example embodiment of the present invention.

FIG. 10A is a perspective view of a body portion of an applicator 62 of an example embodiment of the present invention.

FIG. 10B illustrates an applicator 62 in a reference example.

FIG. 11 is an explanatory view of a replacement assembly 80 of an example embodiment of the present invention.

FIGS. 12A and 12B are explanatory views of a first function of an auxiliary roller 84 of an example embodiment of the present invention.

FIG. 13 is an explanatory view of a shape of the auxiliary roller 84.

FIG. 14 is an explanatory view of a supply-side gear 81A and a winding-side gear 82A of an example embodiment of the present invention.

FIG. 15 is an explanatory view of a table 521 of an example embodiment of the present invention.

FIGS. 16A to 16C are explanatory views of a locking mechanism 78 of an example embodiment of the present invention.

### DETAILED DESCRIPTION OF THE EXAMPLE EMBODIMENTS

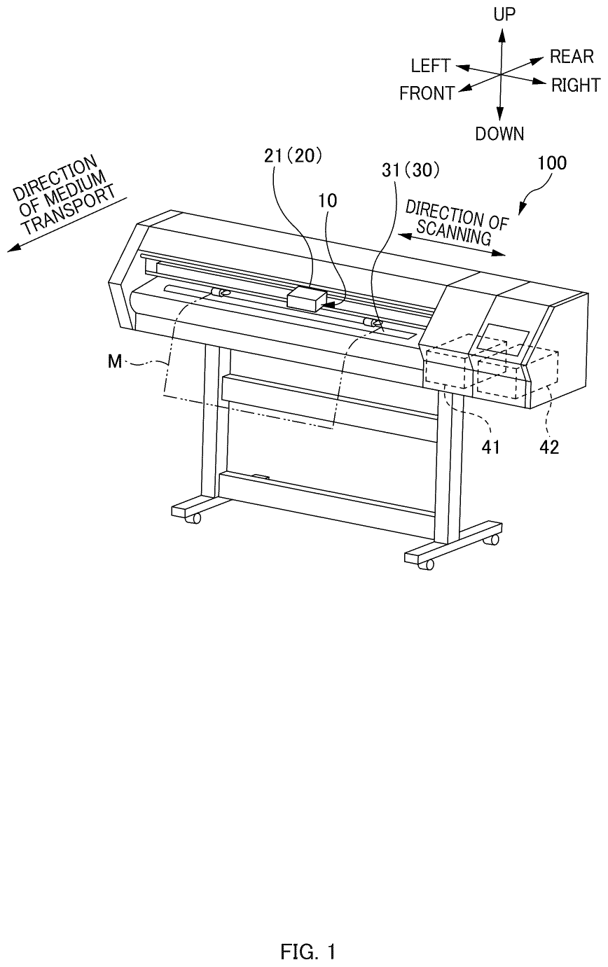

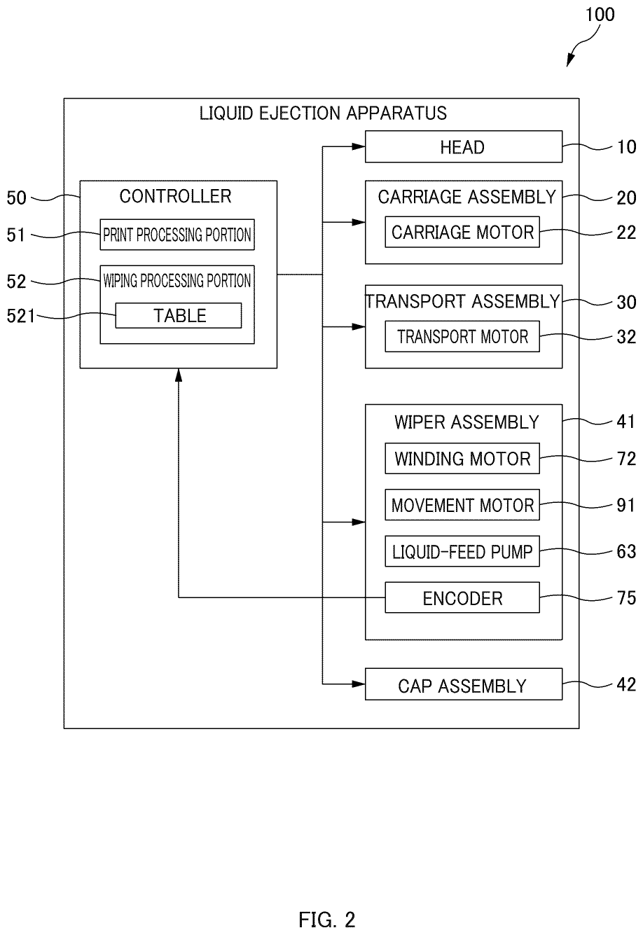

FIG. 1 is a schematic explanatory view of a liquid ejection apparatus 100 of an example embodiment of the present invention. FIG. 2 is a block diagram of the liquid ejection apparatus 100.

In the following description, a direction in which a carriage 21 (or a head 10) moves may be referred to as “direction of scanning” or “left-right direction”. In the left-right direction, a right side of a worker who operates the liquid ejection apparatus 100 may be referred to as “right”, and a side opposite thereto may be referred to as “left”. In addition, a direction in which a medium M is transported may be referred to as “direction of medium transport”. Furthermore, a region where the head 10 ejects a liquid onto the medium M may be referred to as “printing region”, and the direction of medium transport in the printing region may be referred to as “front-rear direction”. In the front-rear direction, an upstream side in the direction of medium transport may be referred to as “rear”, and a downstream side in the direction of medium transport may be referred to as “front”. In the front-rear direction, a side of the worker who operates the liquid ejection apparatus 100 when seen from the liquid ejection apparatus 100 is the “front”, and a side opposite thereto is the “rear”. The front-rear direction may be referred to as “first direction”, and the direction of scanning may be referred to as “second direction”. A direction perpendicular to the direction of scanning and the front-rear direction may be referred to as “up-down direction”, an upper side in the up-down direction may be referred to as “up”, and a side opposite thereto may be referred to as “down”.

The liquid ejection apparatus 100 ejects the liquid onto the medium M (a print sheet, a print film, or the like). Here, the liquid ejection apparatus 100 is an apparatus (preferably an inkjet printer, for example) that prints an image on the medium M. However, the liquid ejection apparatus 100 may not be the apparatus that prints the image on the medium M, as long as it is an apparatus that ejects a liquid from the head 10. The liquid ejection apparatus 100 preferably includes the head 10, a carriage assembly 20, a transport assembly 30, a wiper assembly 41, a cap assembly 42, and a controller 50.

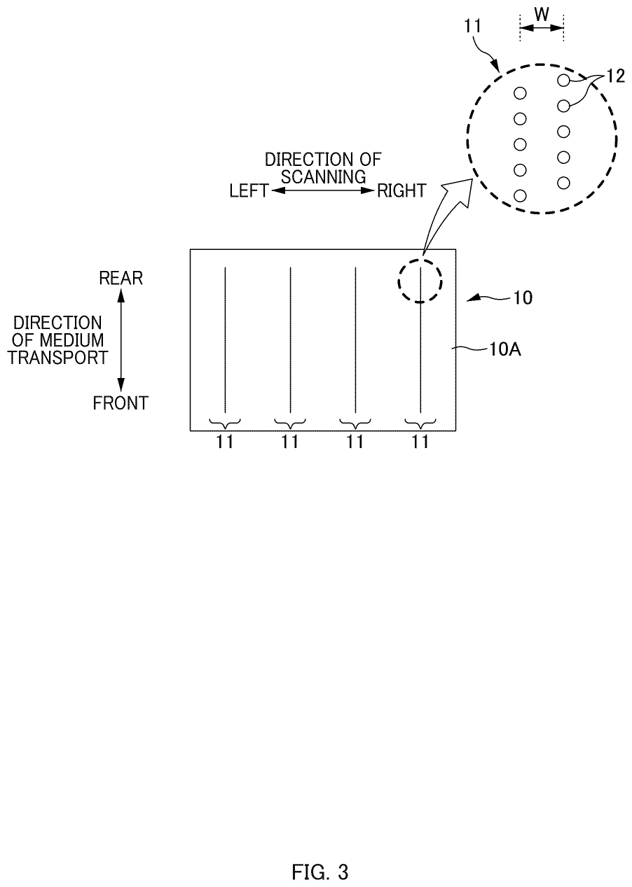

FIG. 3 is an explanatory view of a nozzle surface 10A of the head 10.

The head 10 preferably includes multiple nozzle rows 11. The multiple nozzle rows 11 are positioned at intervals in the direction of scanning. The head 10 in FIG. 3 includes four nozzle rows 11, for example.

Each of the nozzle rows 11 preferably includes multiple nozzles 12. The multiple nozzles 12 of the nozzle row 11 are aligned along the front-rear direction (direction of medium transport). Here, the multiple nozzles 12 of the nozzle row 11 are provided in zigzag arrangement along the front-rear direction. However, the multiple nozzles 12 may be aligned linearly along the front-rear direction.

The nozzle 12 is opened in the nozzle surface 10A of the head 10, and the liquid is ejected from such an opening thereof. For example, the liquid that is to be ejected from the nozzle 12 is ink. The ink ejected from the nozzle 12 arrives at the medium M to form a dot on the medium M, and the image made up of the dots results in being printed on the medium M. However, the liquid to be ejected from the head 10 is not limited to the ink.

The carriage assembly 20 moves the carriage 21. The carriage assembly 20 preferably includes the carriage 21 and a carriage motor 22 to move the carriage 21 in the direction of scanning. The carriage 21 reciprocates in the direction of scanning, and has the head 10 installed therein.

The transport assembly 30 transports the medium M. The medium M to be transported may be a long print medium M such as a rolled sheet, or may be a single sheet of paper. Further, the medium M is not limited to the sheet of paper, and may be, for example, a film, cloth, or the like. The transport assembly 30 has, for example, a transport roller 31 and a transport motor 32 to rotate the transport roller 31. The transport roller 31 rotates to transport the medium M in the direction of medium transport.

The wiper assembly 41 wipes the nozzle surface 10A of the head 10. The wiper assembly 41 in an example embodiment of the present disclosure wipes the nozzle surface 10A by using a sheet S. The wiper assembly 41 will be described below.

The cap assembly 42 caps the nozzle surface 10A of the head 10. The cap assembly 42 includes a cap (not illustrated) to cover the nozzle surface 10A of the head 10. The cap assembly 42 is provided at a home position at which the carriage 21 stands by. The home position is provided at an end portion (a right end portion herein) of a moving range of the carriage 21.

The controller 50 is configured or programmed to control the liquid ejection apparatus 100. The controller 50 is configured or programmed to control components (the head 10, the carriage assembly 20 (specifically, the carriage motor 22), the transport assembly 30 (specifically, the transport motor 32), the wiper assembly 41, and the cap assembly 42) of the liquid ejection apparatus 100. The controller 50 preferably includes an arithmetic processor and a storage device, which are not illustrated. The arithmetic processor includes, for example, a CPU, an MPU, or the like. The storage device preferably includes RAM used to execute a program, ROM that stores a program, and the like. The arithmetic processor executes the program stored in the storage device to execute various types of processes (a wiping process described below and the like). FIG. 2 illustrates a functional block of the controller 50. The controller 50 preferably is configured or programmed to include a print processing portion 51 and a wiping processing portion 52.

The print processing portion 51 executes a print process. Specifically, the print processing portion 51 alternately repeats a liquid ejection operation and a medium transport operation to print the image on the medium M. The liquid ejection operation is an operation of ejecting the liquid from the head 10 while the carriage assembly 20 (the carriage motor 22) is being driven to move the head 10 in the direction of scanning. The medium transport operation is an operation of driving the transport assembly 30 (the transport motor 32) to transport the medium M in the direction of medium transport. Further, the wiping processing portion 52 performs the wiping process to wipe the nozzle surface 10A of the head 10 by using the sheet S. The wiping process will be described below.

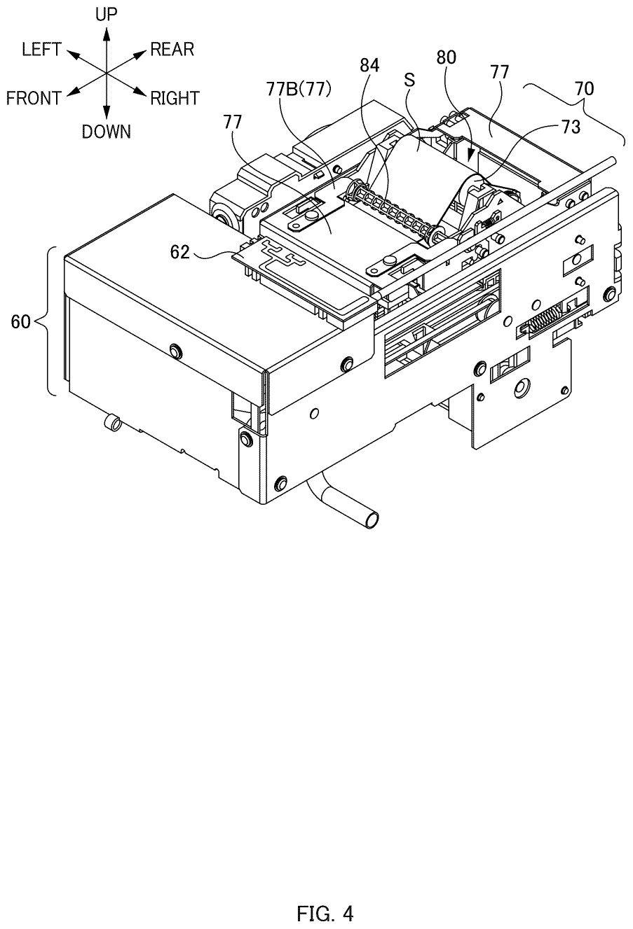

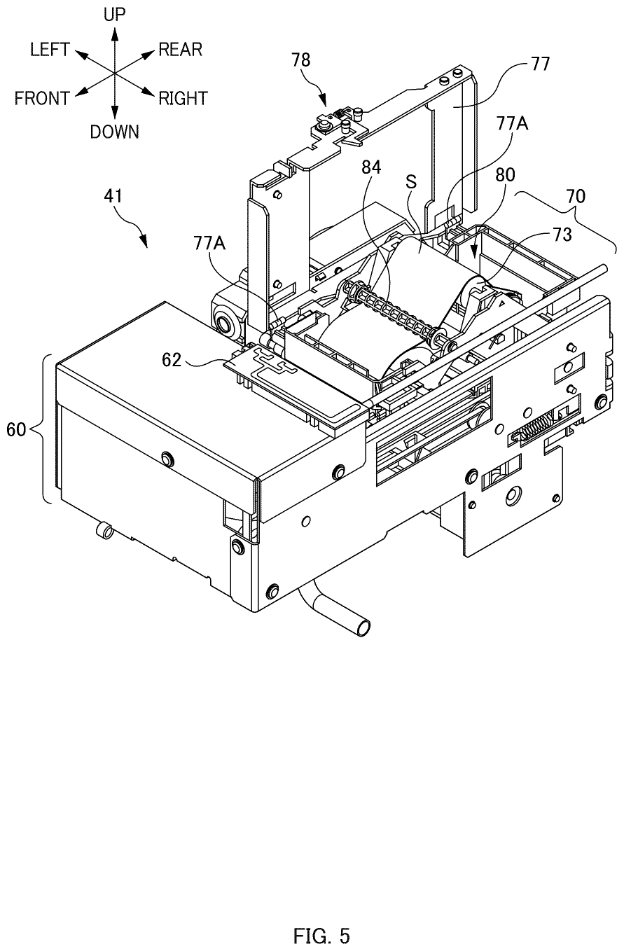

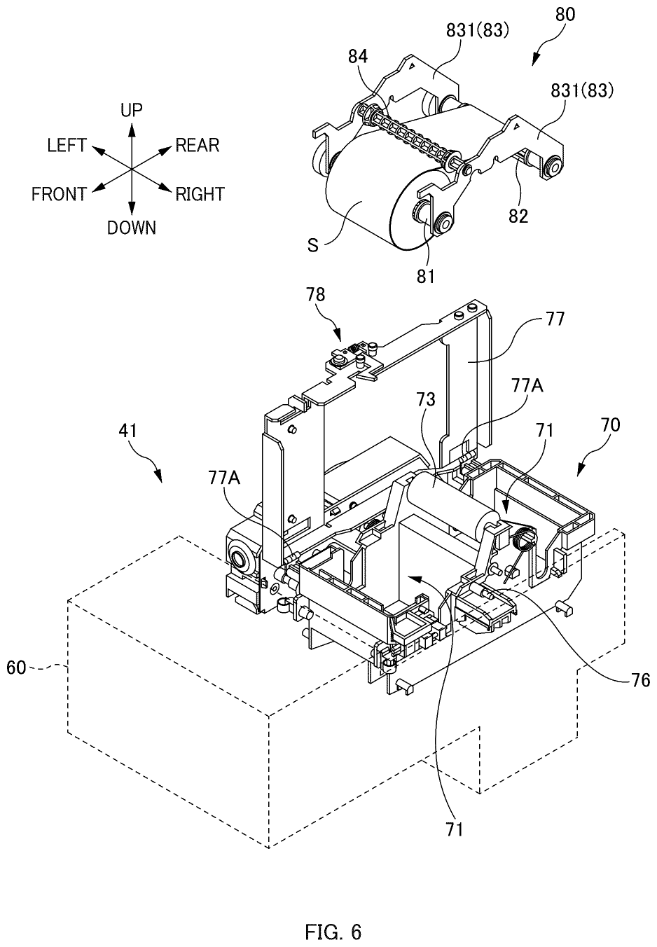

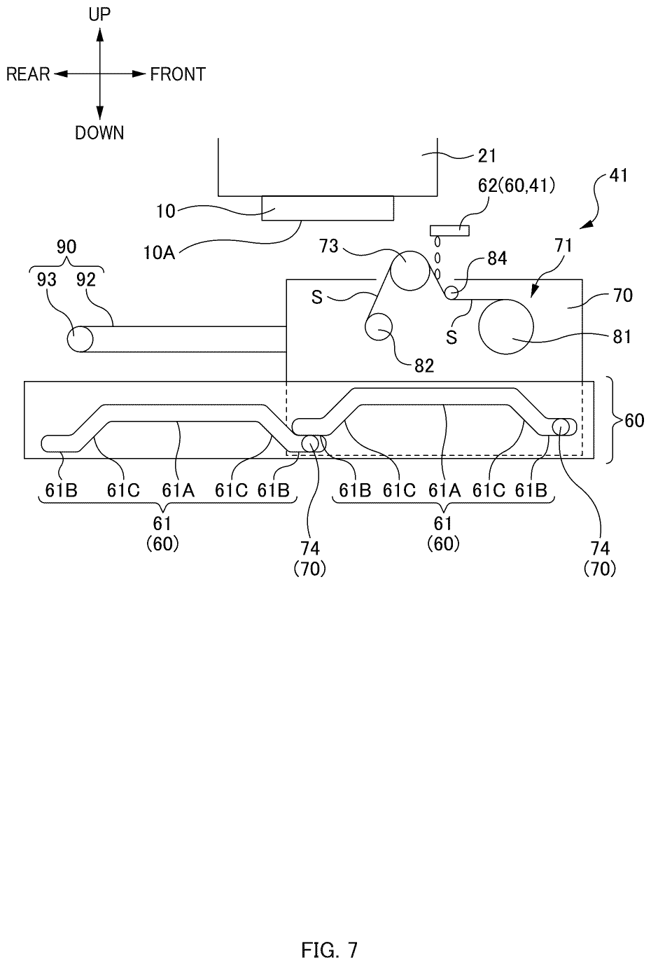

FIG. 4 is a perspective view of the wiper assembly 41. FIG. 5 is an explanatory view of a state where a cover 77 is opened. FIG. 6 is an explanatory view of a state where a replacement assembly 80 is taken out from a movable body 70. In FIG. 6, a base 60 is transparent. FIG. 7 is a schematic explanatory view of the wiper assembly 41.

The wiper assembly 41 preferably includes the base 60, the movable body 70, and a movement mechanism 90.

The base 60 is fixed to the liquid ejection apparatus 100. The base 60 includes a base-side guide 61, an applicator 62, and a liquid-feed pump 63 (see FIG. 2).

The base-side guide 61 guides the movable body 70 in the front-rear direction. The base-side guide 61 also guides the movable body 70 in the up-down direction when the movable body 70 moves in the front-rear direction. A moving-side guide 74 of the movable body 70 is engaged with the base-side guide 61. The base-side guide 61 includes a slide portion 61A, standby portions 61B, and slope portions 61C. The slide portion 61A guides the movable body 70 in the front-rear direction while making the sheet S in contact with the nozzle surface 10A of the head 10. The standby portion 61B causes the movable body 70 to stand by at a position at which the sheet S and the nozzle surface 10A of the head 10 are separated from each other. The slope portion 61C is an inclined portion between the slide portion 61A and the standby portion 61B, and is configured to lift/lower the movable body 70.

The applicator 62 applies a cleaning solution to the sheet S. A detailed configuration of the applicator 62 will be described below.

The liquid-feed pump 63 (see FIG. 2) supplies the cleaning solution to the applicator 62. When the liquid-feed pump 63 supplies the cleaning solution to the applicator 62, the cleaning solution is ejected from the applicator 62 to apply the cleaning solution to the sheet S.

The movable body 70 can move in the front-rear direction (the first direction) with respect to the base 60. The movable body 70 accommodates the sheet S. The sheet S wipes the nozzle surface 10A of the head 10. The sheet S is a sheet-shaped (belt-shaped) structure, and is formed of non-woven fabric, for example. A width direction of the sheet S is parallel or substantially parallel to the direction of scanning (the second direction).

The movable body 70 also accommodates a supply roller 81 and a winding roller 82. The unused sheet S is wound on the supply roller 81 in advance. The used sheet S is wound onto the winding roller 82. The sheet S extends between the supply roller 81 and the winding roller 82, and the sheet S is supplied from the supply roller 81 to the winding roller 82. In the following description, a direction in which the sheet S is transported from the supply roller 81 toward the winding roller 82 may be referred to as “direction of sheet transport”. The direction of sheet transport is a direction perpendicular to the direction of scanning (the second direction).

As illustrated in FIG. 6, the movable body 70 accommodates the replacement assembly 80 that includes the sheet S, the supply roller 81, and the winding roller 82. The replacement assembly 80 will be described below.

The movable body 70 preferably includes an accommodation portion 71, a winding motor 72, a pressing roller 73, and the moving-side guide 74.

The accommodation portion 71 is a portion (a space) in which the sheet S, the supply roller 81, and the winding roller 82 are accommodated. The replacement assembly 80 can be attachable/detachable to/from the accommodation portion 71 (which will be described below).

The winding motor 72 (see FIG. 2) is a motor that rotates the winding roller 82 in a direction of winding. The winding roller 82 is rotated in the direction of winding by the winding motor 72 to supply the sheet S from the supply roller 81.

The pressing roller 73 presses the sheet S against the nozzle surface 10A of the head 10. The sheet S spans the pressing roller 73. At a top of the pressing roller 73, the sheet S is pressed against the nozzle surface 10A. The direction of sheet transport at the top of the pressing roller 73 is a direction from the front side toward the rear side, and is parallel or substantially parallel with the front-rear direction (the direction of medium transport; the first direction).

The moving-side guide 74 (see FIG. 7) is engaged with the base-side guide 61 of the base 60. The movable body 70 moves in the front-rear direction while the moving-side guide 74 is engaged with the base-side guide 61 to displace the movable body 70 in the up-down direction.

The movement mechanism 90 (see FIG. 7) moves the movable body 70 in the front-rear direction with respect to the base 60. Here, the movement mechanism 90 includes a movement motor 91 (see FIG. 2), a belt 92 (see FIG. 7), and a pulley 93 (see FIG. 7). However, the movement mechanism 90 is not limited to the mechanism using the belt 92 as long as the movable body 70 can move in the front-rear direction.

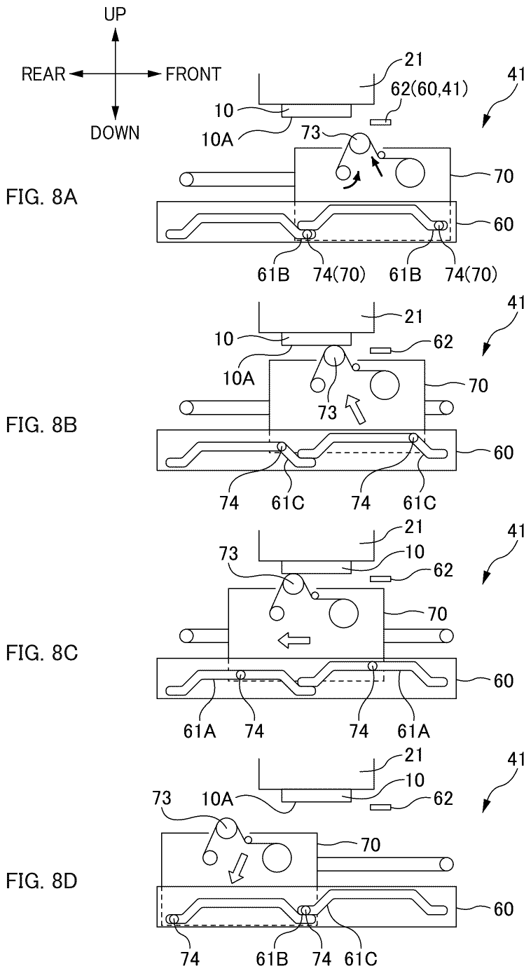

FIGS. 8A to 8D are schematic explanatory views of the wiping process performed by the wiper assembly 41. Here, a description will be given of the wiping process with reference to FIGS. 7 and 8A to 8D.

First, as illustrated in FIG. 7, the controller 50 (the wiping processing portion 52) is configured or programmed to control the movement motor 91 so as to move the movable body 70 forward. In this event, the moving-side guide 74 of the movable body 70 is at the standby portion 61B of the base-side guide 61. The applicator 62 is positioned on the rear side relative to the supply roller 81, and is positioned on the front side relative to the pressing roller 73. Further, the sheet S is below the applicator 62. At a position below the applicator 62, the sheet S is inclined with respect to the front-rear direction and the up-down direction.

The controller 50 (the wiping processing portion 52) is configured or programmed to control the liquid-feed pump 63, so as to supply the cleaning solution to the applicator 62, thus causing the cleaning solution to drip onto the sheet S from the applicator 62, to apply the cleaning solution to the sheet S, as illustrated in FIG. 7. The applicator 62 applies the cleaning solution to the sheet S in a region between the supply roller 81 and the pressing roller 73 (specifically, a region between an auxiliary roller 84 and the pressing roller 73). This makes it possible to apply the cleaning solution to the unused sheet S on the upstream side relative to the pressing roller 73 in the direction of sheet transport. Since the sheet S is inclined at the position below the applicator 62, the cleaning solution applied to the sheet S can easily wet and spread along the longitudinal direction of the sheet S.

After applying the cleaning solution to the sheet S, as illustrated in FIG. 8A, the controller 50 (the wiping processing portion 52) is configured or programmed to control the winding motor 72 so as to transport the sheet S such that a region where the cleaning solution has been applied is positioned at the top of the pressing roller 73. After the region where the cleaning solution has been applied being transported to the top of the pressing roller 73, the controller 50 is configured or programmed to control the movement motor 91 so as to move the movable body 70 rearward (see FIGS. 8B to 8D). In response to the movable body 70 being moved rearward, the movable body 70 (the moving-side guide 74) is lifted by the slope portion 61C of the base-side guide 61, and the sheet S (the region where the cleaning solution has been applied) comes into contact with the nozzle surface 10A of the head 10, as illustrated in FIG. 8B. Further, as illustrated in FIG. 8C, while the sheet S is in contact with the nozzle surface 10A of the head 10, the movable body 70 (the moving-side guide 74) is guided, by the slide portion 61A of the base-side guide 61, to move rearward, and the nozzle surface 10A of the head 10 is wiped w the sheet S. As illustrated in FIG. 8D, the movable body 70 (the moving-side guide 74) is lowered by the slope portion 61C of the base-side guide 61, and the sheet S separates from the nozzle surface 10A of the head 10.ith

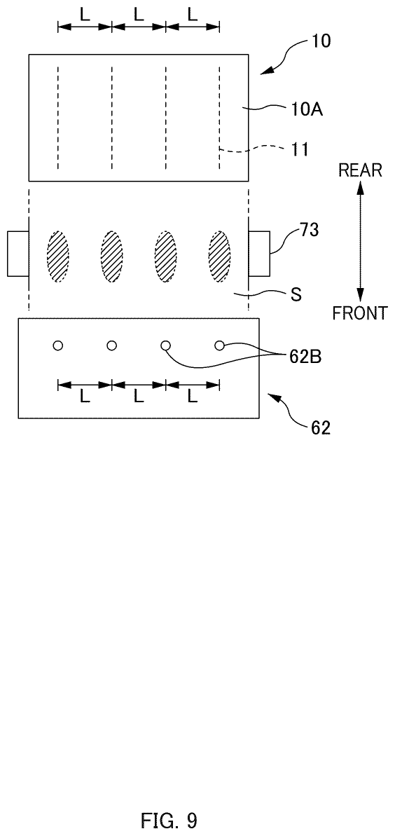

FIG. 9 is an explanatory view of positional relationships between ejection ports 62B of the applicator 62 and the nozzle rows 11 of the head 10. The sheet S that has been transported to the top of the pressing roller 73 is illustrated between the applicator 62 and the head 10 in FIG. 9, and regions of the sheet S applied with the cleaning solution are hatched. In the following description, the region of the sheet S where the cleaning solution has been applied (the hatched region in FIG. 9) may be referred to as “application region”.

The applicator 62 includes the multiple ejection ports 62B. Each of the ejection ports 62B is an opening to eject the cleaning solution toward the sheet S. The number of the ejection ports 62B is the same as the number of the nozzle rows 11 of the head 10, for example. Since the four nozzle rows 11 are provided in the nozzle surface 10A of the head 10 (see FIG. 3), the four ejection ports 62B are provided to the applicator 62 herein, for example.

The multiple ejection ports 62B are positioned at predetermined intervals in the direction of scanning. The intervals of the ejection ports 62B are equal to intervals of the nozzle rows 11, for example. Accordingly, during the wiping process, the positions of the nozzle rows 11 of the head 10 in the direction of scanning can be aligned with the positions of the ejection ports 62B of the applicator 62 in the direction of scanning, respectively, and the nozzle rows 11 can be located behind the ejection ports 62B, respectively. Note that, during the wiping process, the controller 50 (the wiping processing portion 52) moves the head 10 to a predetermined position such that the nozzle rows 11 of the head 10 are positioned behind the ejection ports 62B, respectively.

FIG. 9 illustrates a situation where the four nozzle rows 11 provided in the nozzle surface 10A of the head 10 are positioned at intervals L in the direction of scanning and the four ejection ports 62B of the applicator 62 are positioned at the intervals L in the direction of scanning. However, the three intervals defined by the four nozzle rows 11 may not be equal to one another, and the three intervals defined by the four ejection ports 62B may not be equal to one another. For example, in the case where the three intervals defined by the four nozzle rows 11 are L1, L2, and L3 from the left, the three intervals defined by the four ejection ports 62B only need to be set as L1, L2, and L3 from the left, similarly. As such, even when the intervals between the nozzle rows 11 are not equal to one another, and the intervals between the ejection ports 62B of the applicator 62 are not equal to one another, the intervals of the ejection ports 62B and the intervals of the nozzle rows 11 only need to be set the same.

The ejection ports 62B are positioned at intervals in the direction of scanning, and thus, when a large amount of the cleaning solution is not applied, the application regions (the hatched regions in FIG. 9) are spaced apart from each other in the direction of scanning. That is, a region where the cleaning solution is not applied is present between each two of the application regions. However, in an example embodiment of the present disclosure, the intervals of the ejection ports 62B and the intervals of the nozzle rows 11 are the same, and thus, even when the cleaning solution is not applied to the entire region of the sheet S in the width direction, it is possible to wipe the nozzle surface 10A where the nozzle rows 11 is provided, using the application regions (the hatched regions in FIG. 9). Therefore, in an example embodiment of the present disclosure, it is possible to reduce the amount of consumption of the cleaning solution.

A diameter of the ejection port 62B is preferably greater than a width of the nozzle row 11 (a dimension thereof in the direction of scanning). Thus, the diameter of the ejection port 62B is larger than a diameter of the nozzle 12 of the head 10. Further, as illustrated in FIG. 3, in the case where the single nozzle row 11 is defined by the multiple nozzles 12 that are provided in the zigzag pattern, the diameter of the ejection port 62B is desirably greater than a width W of the nozzle row 11 (see FIG. 3). For example, while the width W of the nozzle row 11 (see FIG. 3) is preferably set at 1.0 mm or about 1.0 mm, the diameter of the ejection port 62B is preferably set at 1.2 mm or about 1.2 mm. Accordingly, the nozzle row 11 can be wiped in the application region. In the case where the cleaning solution, which has dripped onto the sheet S, wets and spreads, and a width of the application region in the direction of scanning becomes greater than the width of the nozzle row 11, the diameter of the ejection port 62B may be equal to or less than the width of the nozzle row 11.

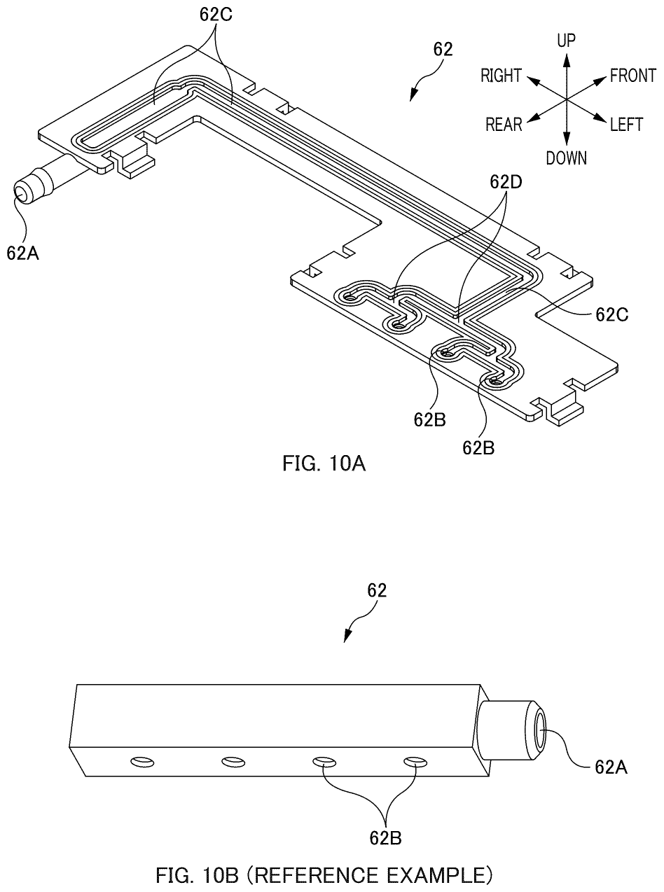

FIG. 10A is a perspective view of a body portion of the applicator 62. Here, the applicator 62 includes the body portion illustrated in FIG. 10A and a film (not illustrated) deposited on a surface of the body portion.

The applicator 62 preferably includes a supply port 62A, the multiple ejection ports 62B and flow paths 62C. The supply port 62A is an opening to supply the cleaning solution. As has been described above, each of the ejection ports 62B is an opening to eject the cleaning solution toward the sheet S. The flow paths 62C are each a path through which the cleaning solution supplied from the supply port 62A is to flow to each of the ejection ports 62B. A groove is provided in the surface of the body portion, and the flow path 62C is defined by a space between the groove and the film (not illustrated) vapor-deposited on the body portion. However, the applicator 62 does not have to be configured as such, as long as it includes a structure capable of applying the cleaning solution to the sheet S. For example, the applicator 62 may include a tubular structure.

The flow paths 62C illustrated in FIG. 10A are provided with a branch portion 62D. The branch portion 62D is a portion where a flow of the cleaning solution branches off. The branch portions 62D are provided such that lengths of the flow paths 62C from the supply port 62A to the ejection ports 62B are equal or substantially equal. This make it possible that the amounts of the cleaning solution ejected from the respective ejection ports 62B can be made equal or substantially equal.

FIG. 10B illustrates the applicator 62 in a reference example. In the reference example, the branch portion 62D is not provided to the flow paths 62C. Accordingly, in the reference example, the lengths of the flow paths 62C from the supply port 62A to the ejection ports 62B are preferably different depending on the ejection ports 62B. As a result, there is a possibility that the shorter the length of the flow path 62C is and the greater the amount of ejection of the cleaning solution will be, and there is also a possibility that the more distant the ejection port 62B is from the supply port 62A, the longer the length of the flow path 62C is and the smaller the amount of ejection of the cleaning solution will be. Further, in the case of the applicator 62 in the reference example, when an attempt is made to eject a needed amount of the cleaning solution from the ejection port 62B, which is positioned distant from the supply port 62A, an excessive amount of the cleaning solution is ejected from the ejection port 62B located closer to the supply port 62A. Thus, the amount of consumption of the cleaning solution is increased. In contrast, in an example embodiment of the present disclosure, the branch portion 62D provided to the flow paths 62C is to equalize the lengths of the flow paths 62C, thus being able to equalize the amounts of the cleaning solution that are ejected from the respective ejection ports 62B, and reducing the amount of consumption of the cleaning solution.

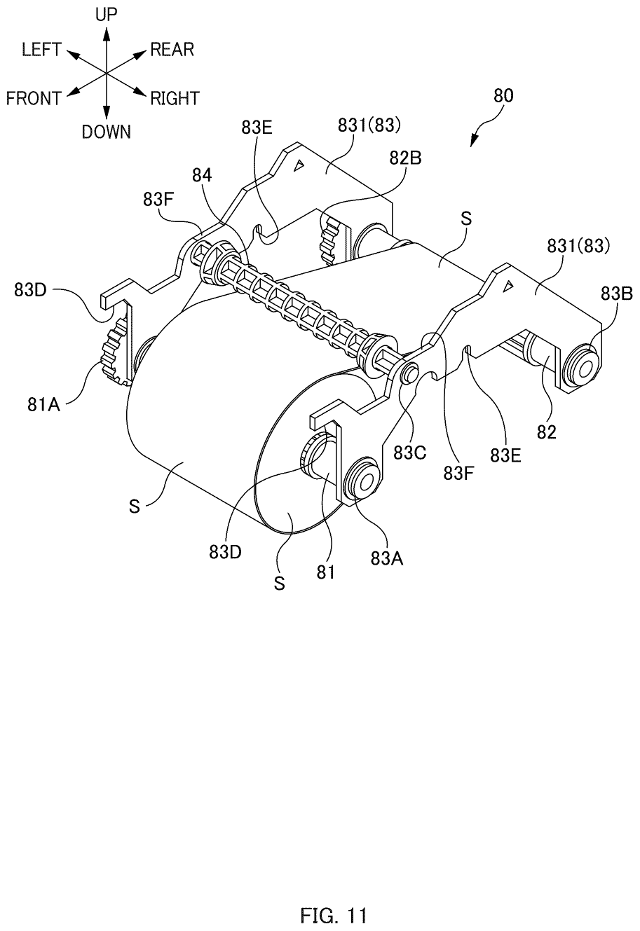

FIG. 11 is an explanatory view of the replacement assembly 80.

The replacement assembly 80 is configured to replace the sheet S and to be attachable/detachable to/from the movable body 70. As illustrated in FIG. 6, the replacement assembly 80 is to be accommodated in the accommodation portion 71 of the movable body 70.

The replacement assembly 80 preferably includes the sheet S, the supply roller 81, the winding roller 82, a holding portion 83, and the auxiliary roller 84. Note that the pressing roller 73 is not provided on the replacement assembly 80 side, but provided to the accommodation portion 71 that is to accommodate the replacement assembly 80. This is because the pressing roller 73 is an expensive structure that needs high dimensional accuracy. However, the pressing roller 73 may be provided to the replacement assembly 80.

As has been described above, the sheet S is preferably a sheet-shaped structure to wipe the nozzle surface 10A of the head 10. In the replacement assembly 80 before use, the unused sheet S is wound on the supply roller 81 in advance. In the replacement assembly 80 after use, the used sheet S is wound on the winding roller 82.

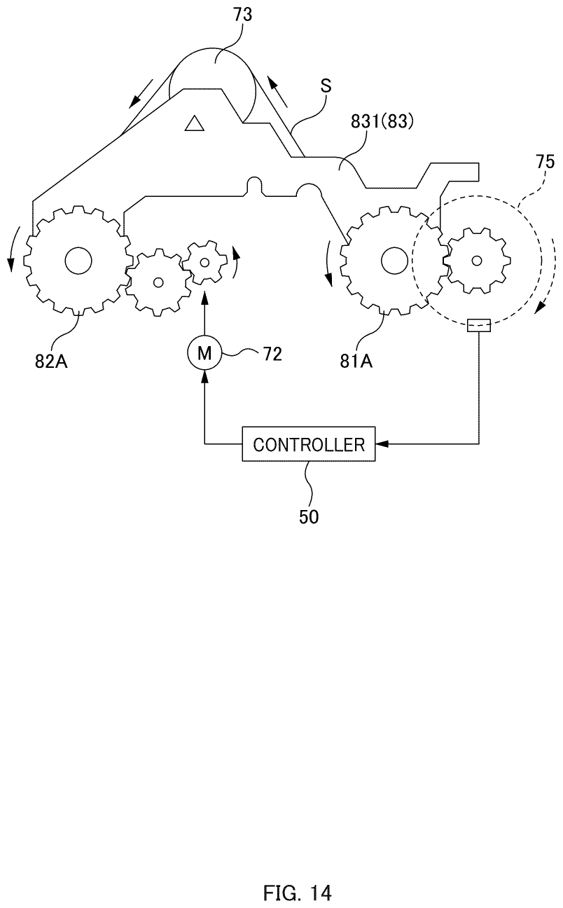

A supply-side gear 81A is provided at an end of the supply roller 81. The supply-side gear 81A transmits a rotational force to a rotary encoder 75 (which will be described below; see FIG. 14). A winding-side gear 82A is provided at an end of the winding roller 82. The winding-side gear 82A is a gear (a driven gear) that meshes with a drive-side gear (see FIG. 14) provided to the winding motor 72. A configuration is made such that the winding-side gear 82A meshes with the drive-side gear provided to the winding motor 72, with the replacement assembly 80 being accommodated in the accommodation portion 71 of the movable body 70. Together with the drive-side gear provided to the winding motor 72, the winding-side gear 82A defines a transmission mechanism to transmit the rotational force of the winding motor 72 to the winding roller 82.

The holding portion 83 holds the supply roller 81 and the winding roller 82. The holding portion 83 has a function of holding a rotation shaft of the supply roller 81 and a rotation shaft of the winding roller 82 in parallel or substantially in parallel. In the case where the rotation shaft of the supply roller 81 is not parallel with the rotation shaft of the winding roller 82, a wrinkle may be formed in the sheet S, or the sheet S may be transported unevenly in the width direction. Thus, it is needed to set the rotation shaft of the supply roller 81 in parallel or substantially in parallel with the rotation shaft of the winding roller 82. Meanwhile, in order to replace the sheet S, the supply roller 81 and the winding roller 82 also need to be replaced, however, when a positional relationship between the supply roller 81 and the winding roller 82 is not fixed, it is difficult to attach the supply roller 81 and the winding roller 82 in parallel or substantially in parallel. In contrast, in an example embodiment of the present disclosure, the holding portion 83 holds the supply roller 81 and the winding roller 82 such that the rotation shafts thereof will be in parallel or substantially in parallel to facilitate work of accommodating the supply roller 81 and the winding roller 82 in the accommodation portion 71 such that the rotation shafts thereof will be in parallel or substantially in parallel when replacing the sheet S.

The holding portion 83 includes a pair of holding portions 831. Each of the holding portions 831 is preferably defined by of a plate-shaped structure, and the pair of holding portions 831 holds two ends of the supply roller 81 and the two ends of the winding roller 82, respectively. As such, the holding portion 83 holds both the two ends of the supply roller 81 and the two ends of the winding roller 82 to facilitate holding the supply roller 81 and the winding roller 82 in parallel or substantially in parallel, as compared to a case where the ends, on one side, of the supply roller 81 and the winding roller 82 are held in a cantilevered manner.

The holding portion 831 preferably includes a first bearing portion 83A, a second bearing portion 83B, a third bearing portion 83C, a first support portion 83D, a second support portion 83E, and a contact portion 83F. The first bearing portion 83A rotatably supports the supply roller 81. The second bearing portion 83B rotatably supports the winding roller 82. The third bearing portion 83C rotatably supports the auxiliary roller 84 (which will be described below). The first support portion 83D and the second support portion 83E are portions that are supported by the movable body 70 (the accommodation portion 71). The first support portion 83D and the second support portion 83E also have a function of aligning the replacement assembly 80 in a predetermined position with respect to the movable body 70. The contact portion 83F is a portion to come into contact with the cover 77, and is a portion that is to be held down from above by the cover 77. The contact portion 83F is defined by an upper edge of the holding portion 831. The first support portion 83D and the second support portion 83E are spaced apart in the front-rear direction, and the contact portion 83F is between the first support portion 83D and the second support portion 83E. With the contact portion 83F being between the first support portion 83D and the second support portion 83E, the replacement assembly 80 can stably be accommodated in the accommodation portion 71.

The holding portion 831 preferably includes a metal structure and, more specifically, sheet metal. Since the holding portion 831 is made of metal, it is possible to firmly maintain a positional relationship between the rotation shaft of the supply roller 81 and the rotation shaft of the winding roller 82, as compared to a case where the holding portion 831 is made of a resin.

The paired holding portions 831 preferably have the same shape as each other. For example, the paired holding portions 831 can be punched by using the same punching die and thus have the same shape. Since the paired holding portions 831 have the same shape, a positional relationship between the first bearing portion 83A and the second bearing portion 83B is the same in each of the holding portions 831, thus being able to easily configure the holding portion 83 that holds the rotation shaft of the supply roller 81 and the rotation shaft of the winding roller 82 in parallel or substantially in parallel. In particular, by using the same die to form the paired holding portions 831, it is possible to reduce or prevent a difference in a distance between the first bearing portion 83A and the second bearing portion 83B, which is caused by an influence of tolerance, thus being able to easily configure the holding portion 83 that holds the rotation shaft of the supply roller 81 and the rotation shaft of the winding roller 82 in parallel or substantially in parallel. Further, when the paired holding portions 831 have the same shape, it is possible to reduce the manufacturing cost of the holding portions 831. However, the paired holding portions 831 may not have the same shape, as long as the rotation shaft of the supply roller 81 and the rotation shaft of the winding roller 82 can be held in parallel or substantially in parallel.

The auxiliary roller 84 is between the supply roller 81 and the winding roller 82 in the front-rear direction. As illustrated in FIG. 11, in a state before the replacement assembly 80 is accommodated in the accommodation portion 71, the auxiliary roller 84 does not have to be in contact with the sheet S that extends between the supply roller 81 and the winding roller 82. As illustrated in FIG. 5, when the replacement assembly 80 is accommodated in the accommodation portion 71, the sheet S extending between the supply roller 81 and the winding roller 82 is pushed up by the pressing roller 73 to bring the auxiliary roller 84 to come into contact with a surface (a surface to contact the nozzle surface 10A; a surface to be applied with the cleaning solution) of the sheet S extending between the supply roller 81 and the pressing roller 73. In a state where the replacement assembly 80 is accommodated in the accommodation portion 71, the auxiliary roller 84 is between the supply roller 81 and the pressing roller 73.

Each end of the auxiliary roller 84 is rotatably supported by the third bearing portion 83C of the holding portion 83 (the holding portion 831). The auxiliary roller 84 is held in parallel or substantially in parallel with the supply roller 81 and the winding roller 82 by the holding portion 83. Since the auxiliary roller 84 is held in parallel or substantially in parallel with the supply roller 81 and the winding roller 82, it is possible to prevent the wrinkle from being formed in the sheet S or the sheet S from being transported unevenly in the width direction.

The auxiliary roller 84 has a function of reducing or preventing a change in a posture of the sheet S. The auxiliary roller 84 has a function of reducing or preventing a change in an inclination angle of the sheet S at a position where the cleaning solution is applied (a first function) and a function of reducing or preventing a change in a position of the sheet S in the width direction (a second function). Hereinafter, a description will be given of these two functions of the auxiliary roller 84.

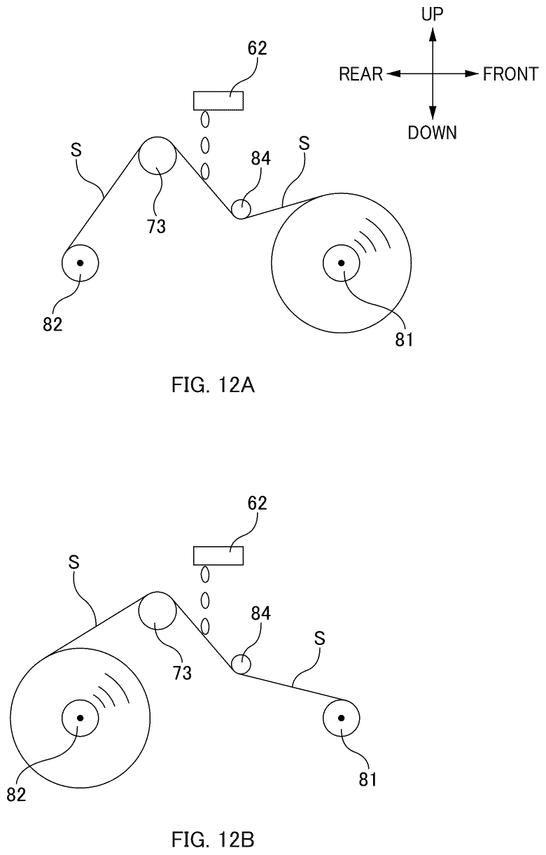

FIGS. 12A and 12B are explanatory views of the first function of the auxiliary roller 84. FIG. 12A is an explanatory view of a situation where a large portion of the sheet S is wound on the supply roller 81. FIG. 12B is an explanatory view of a situation where the large portion of the sheet S is wound on the winding roller 82.

The auxiliary roller 84 is between the supply roller 81 and the pressing roller 73, and is in contact with the surface of the sheet S that extends between the supply roller 81 and the pressing roller 73. Further, the auxiliary roller 84 is on the front side relative to the applicator 62, and the applicator 62 resulting in applying the cleaning solution to the sheet S in the region between the auxiliary roller 84 and the pressing roller 73 (that is, the applicator 62 applies the cleaning solution to the sheet S that extends between the auxiliary roller 84 and the pressing roller 73). In the case where the auxiliary roller 84 is not provided, the inclination angle of the sheet S at the position where the cleaning solution is applied changes according to the amount of winding of the sheet S wound on the supply roller 81. In contrast, with the auxiliary roller 84 being provided between the supply roller 81 and the pressing roller 73, it is possible to maintain the inclination angle of the sheet S at the position where the cleaning solution is applied to be constant, regardless of the amount of winding of the sheet S wound on the supply roller 81 (the first function).

The auxiliary roller 84 preferably is positioned such that a lower edge of the auxiliary roller 84 is below a tangent line contacting an upper edge of the supply roller 81 and an upper edge of the pressing roller 73. This makes it possible to cause the auxiliary roller 84 to come into contact with the surface of the sheet S, regardless of the amount of winding of the sheet S wound on the supply roller 81. Note that the auxiliary roller 84 may be configured so as not to be in contact with the sheet S in a state where the sheet S is hardly wound on the supply roller 81 (a state where the large portion of the sheet S is wound on the winding roller 82), as long as the auxiliary roller 84 is configured so as to be in contact with the sheet S in the state where the large portion of the sheet S is wound on the supply roller 81. Even in such a case, it is possible to reduce or prevent a change in the inclination angle of the sheet S at the position where the cleaning solution is applied, as compared to a case where the auxiliary roller 84 is not provided. Thus, the lower edge of the auxiliary roller 84 does not have to be positioned below the tangent line that contacts the upper edge of the supply roller 81 and the upper edge of the pressing roller 73.

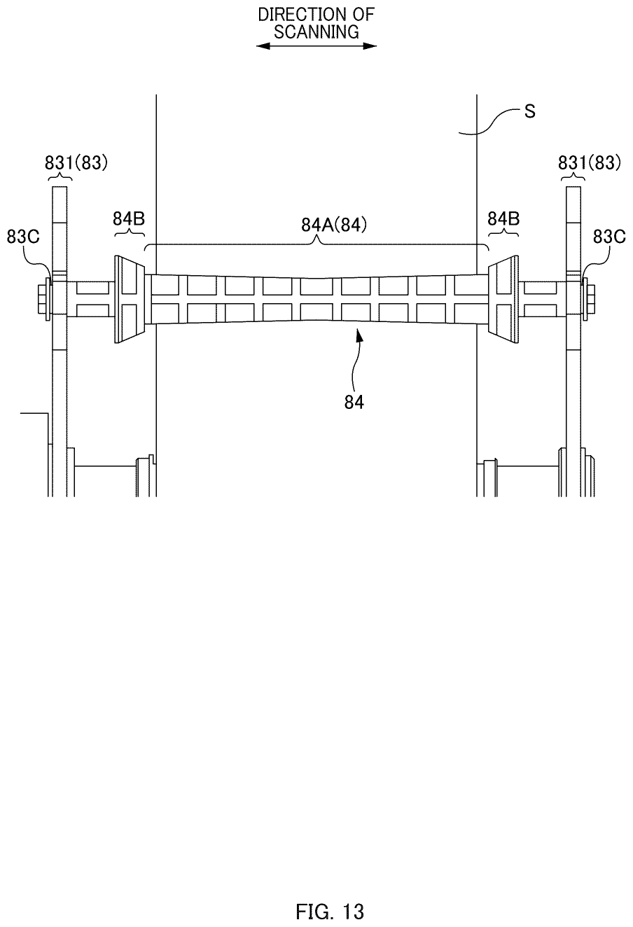

FIG. 13 is an explanatory view of a shape of the auxiliary roller 84.

The auxiliary roller 84 preferably includes a main shaft portion 84A and a pair of brim portions 84B.

The main shaft portion 84A is able to come into contact with the sheet S. The main shaft portion 84A is configured such that the diameter thereof gradually decreases (becomes thinner) toward a center portion thereof. This makes it possible to prevent the sheet S from becoming uneven on one side in the width direction and thus to reduce or prevent a change in the position of the sheet S in the width direction (the second function).

The brim portion 84B is a brim-shaped portion that is provided at both ends of the main shaft portion 84A. The brim portion 84B is between the third bearing portion 83C and the main shaft portion 84A, resulting in the main shaft portion 84A being between the paired brim portions 84B. The brim portion 84B has a larger diameter than the main shaft portion 84A, and a step is provided between the brim portion 84B and the main shaft portion 84A. Each edge of the sheet S is pressed by an inner surface (a stepped surface) of each of the brim portions 84B to prevent the sheet S from becoming uneven (the second function).

The brim portion 84B in FIG. 13 is preferably tapered. Accordingly, the brim portion 84B is configured such that the diameter thereof gradually decreases toward the center portion. By virtue of the brim portion 84B having a tapered surface, even if the sheet S rides on the step between the main shaft portion 84A and the brim 84B and moves unevenly to one side, the sheet S can be returned to the main shaft portion 84A (the second function). The main shaft portion 84A is configured such that the diameter thereof gradually decreases toward the center portion as well, however, an angle of the tapered surface of the brim portion 84B is larger than a tapered angle of the main shaft portion 84A. This is because, when the sheet S is placed unevenly to the brim portion 84B side, the sheet S has to be returned to the center portion promptly.

The brim portion 84B may not be tapered. Further, the brim portion 84B may not be provided to the auxiliary roller 84. Further, the main shaft portion 84A may be configured such that the diameter thereof is constant. The auxiliary roller 84 may not have both of the first function and the second function, but may have at least either one of the functions. The replacement assembly 80 may not include the auxiliary roller 84.

FIG. 14 is an explanatory view of the supply-side gear 81A and the winding-side gear 82A.

As has been described above, the winding-side gear 82A is provided to the one end of the winding roller 82. The winding-side gear 82A is configured to mesh with the drive-side gear that is provided to the winding motor 72, and transmits the rotational force of the winding motor 72 to the winding roller 82 to rotate the winding roller 82 in the winding direction. In response to the winding roller 82 rotating in the winding direction, the supply roller 81 rotates due to the tension of the sheet S to supply the sheet S from the supply roller 81.

The supply-side gear 81A is provided to the one end of the supply roller 81. The supply-side gear 81A is a gear to mesh with the driven gear provided to the movable body 70. A configuration is made such that in response to the replacement assembly 80 being accommodated in the accommodation portion 71 of the movable body 70, the supply-side gear 81A meshes with the driven gear. The rotary encoder 75 (specifically, a disc having a slit formed therein; a rotary scale) is attached to a rotational shaft provided with the driven gear. In response to the supply roller 81 rotating, the rotary encoder 75 rotates as well. Together with the driven gear, the supply-side gear 81A defines a transmission mechanism to transmit the rotation of the supply roller 81 to the rotary encoder 75.

The rotary encoder 75 detects the amount of rotation of the supply roller 81. Specifically, the rotary encoder 75 preferably outputs a pulse every time the supply roller 81 rotates by a predetermined angle. The rotary encoder 75 outputs a detection result to the controller 50 (see FIG. 2). The controller 50 drives the winding motor 72, based on the detection result of the rotary encoder 75 (the amount of rotation of the supply roller 81). For example, the controller 50 counts the number of the pulses of the rotary encoder 75, and drives the winding motor 72 until the number of the pulses reaches a predetermined number to transport the sheet S by a predetermined amount.

Incidentally, the amount of supply of the sheet S with respect to the amount of rotation of the supply roller 81 changes according to an amount of the sheet S wound on the supply roller 81 (the amount of winding). For example, as illustrated in FIG. 12A, in the case where the amount of winding of the sheet S on the supply roller 81 is large, the amount of supply of the sheet S with respect to the amount of rotation of the supply roller 81 increases as compared with a case where the amount of winding of the sheet S on the supply roller 81 is small as illustrated in FIG. 12B. Thus, in order to transport the predetermined amount of the sheet S, the controller 50 is configured or programmed to execute the following control.

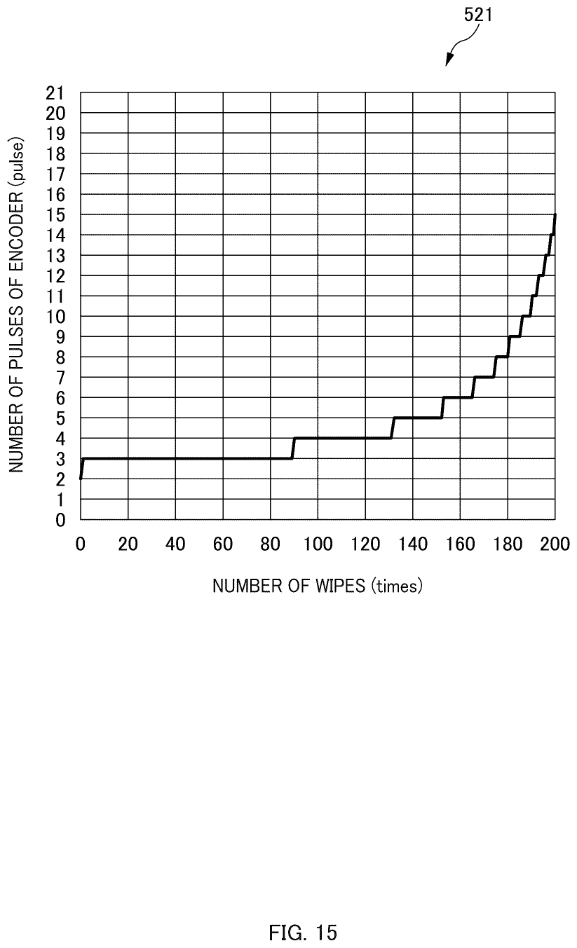

FIG. 15 is an explanatory view of a table 521. The controller 50 (the wiping processing portion 52) stores the table 521 illustrated in FIG. 15 in advance (see FIG. 2).

The table 521 indicates a relationship between the amount of use of the sheet S (the number of wipes herein) and the detection result of the rotary encoder 75.

A horizontal axis in FIG. 15 represents the number of the wipes. As the number of the wipes increases, the amount of use of the sheet S is considered to increase, and thus, the amount (the amount of winding) of the sheet S wound on the supply roller 81 is considered to decrease. The controller 50 increments the number of the wipes each time the wiping process is executed, and resets the number of the wipes to zero when the replacement assembly 80 is replaced.

A vertical axis in FIG. 15 represents the number of the pulses (the target number of the pulses) of the rotary encoder 75 that is needed to transport the predetermined amount (for example, 25 mm) of the sheet S. In the table 521, the target number of the pulses is associated with the number of the wipes such that the target number of the pulses increases with an increase in the number of the wipes.

When transporting the sheet S by the predetermined amount, the controller 50 refers to the table 521 and determines the target number of the pulses corresponding to the number of the wipes. For example, in a situation where the number of the wipes is “100”, the controller 50 determines the target number of the pulses as “4”. Then, the controller 50 drives the winding motor 72 until the number of the pulses outputted from the rotary encoder 75 reaches the target number of the pulses. This makes it possible to transport the sheet S by the predetermined amount.

Here, the controller 50 measures the number of wipes in order to measure the amount of use of the sheet S. However, the controller 50 may directly measure the amount of use of the sheet S. In this case, in the table 521, a relationship between the amount of use of the sheet S and the target number of the pulses is associated with each other. Accordingly, while measuring the amount of use of the sheet S, the controller 50 uses the table 521, to determine the target number of the pulses of the rotary encoder 75, based on the amount of use of the sheet S.

In the case where there is an abnormality in the sheet S, such as a case where there is slack in the sheet S, a case where the sheet S is completely supplied from the supply roller 81 and finished, or a case where the sheet S is cut in the middle, the supply roller 81 may not rotate even with the winding motor 72 being driven. Further, in the case where there is an abnormality in a mechanism to transport the sheet S as well, such as a case where the winding motor 72 fails or a case where any of the transmission mechanisms such as the supply-side gear 81A and the winding-side gear 82A fails, the supply roller 81 may not rotate even with the winding motor 72 being driven. This may be used for the controller 50 to detect that the supply roller 81 does not rotate during driving of the winding motor 72 to detect an abnormality of the wiper assembly 41. Note that, in an example embodiment of the present disclosure, the rotary encoder 75 is provided to detect the amount of rotation of the supply roller 81, and thus such an abnormality can be detected (in the case where the rotary encoder 75 is provided not to detect the amount of rotation of the supply roller 81, but to detect the amount of rotation of the winding roller 82, the controller 50 cannot detect such an abnormality).

As illustrated in FIG. 14, the rotary encoder 75 (specifically, the disc with the slit formed therein; the rotary scale) is provided to the rotational shaft of the driven gear. This makes it possible to increase a degree of freedom in arrangement of the rotary encoder 75 to reduce restrictions on arrangement of the rotary encoder 75, as compared to a case where the rotary encoder 75 is located at the supply roller 81. Further, with the provision of the driven gear to the supply-side gear 81A, it is possible to apply an appropriate amount of back tension to the sheet S to reduce or prevent slack in the sheet S. Furthermore, the rotary encoder 75 is desirably provided to the rotational shaft of the driven gear that has the number of teeth smaller than that of the supply-side gear 81A. This increases a rotation angle of the rotary encoder 75 with respect to a rotation angle of the supply roller 81 to be able to detect the amount of rotation of the supply roller 81 with a high degree of accuracy.

As illustrated in FIGS. 5 and 6, the movable body 70 is provided with the cover 77.

The cover 77 is a structure to hold the replacement assembly 80 from above. The cover 77 is configured to be openable/closable with respect to the movable body 70. When the cover 77 is closed, the cover 77 holds down the replacement assembly 80 from above to prevent detachment of the replacement assembly 80 from the accommodation portion 71 (see FIG. 4). When the cover 77 is opened, the replacement assembly 80 is in a state of being attachable/detachable (see FIGS. 5 and 6).

The cover 77 preferably includes a hinge 77A, a leaf spring 77B (see FIG. 4), and a locking mechanism 78.

The hinge 77A is a structure to allow the cover 77 to be openable/closable, and defines a rotation shaft of the cover 77. The hinge 77A has the rotation shaft that is parallel or substantially parallel to the front-rear direction. Further, the hinge 77A is on the left side relative to the accommodation portion 71. That is, the hinge 77A is closer to the printing region (the region where the head 10 ejects the liquid onto the medium M) than the accommodation portion 71.

Since the hinge 77A is on the left side, the cover 77 is configured to be opened from the right side. As illustrated in FIG. 1, the cap assembly 42 is on the right side relative to the wiper assembly 41 (on the side opposite to the printing region when seen from the wiper assembly 41). A configuration is such that, when the carriage 21 is positioned at the home position (when the cap assembly 42 covers the nozzle surface 10A of the head 10 with the cap), the end portion of the carriage 21 is above the right end portion of the cover 77 to prevent opening of the cover 77. As such, with a configuration in which the hinge 77A is on the left side relative to the accommodation portion 71 (the side opposite to the cap assembly 42 when seen from the wiper assembly 41) and the cover 77 is opened from the right side (on the cap assembly 42 side when seen from the wiper assembly 41), it is possible to make a configuration such that opening of the cover 77 can be prevented by using the carriage 21 at the home position.

In order to open the cover 77, the carriage 21 is to be moved to the printing region. Thus, when the cover 77 is opened as illustrated in FIG. 5, the carriage 21 (not illustrated in FIG. 5) is positioned on the left side of the wiper assembly 41. Accordingly, even in the case where the carriage 21 unexpectedly moves and comes into contact with the cover 77 while the cover 77 is opened as illustrated in FIG. 5, the cover 77 is applied with a force in a direction of closing the cover 77, and thus, it is possible to reduce or prevent damage to the cover 77. Note that, in the case where the cover 77 is opened as illustrated in FIG. 5 and the cover 77 is applied with the force in the direction of further opening the cover 77, the hinge 77A may be damaged. Further, in the case where the rotation shaft of the cover 77 is parallel or substantially parallel not with the front-rear direction but with the direction of scanning, for example, and the carriage 21 unexpectedly moves and comes into contact with the cover 77 while the cover 77 is opened, the cover 77 may be damaged. In contrast, as in an example embodiment of the present disclosure, with a configuration in which the hinge 77A is on the left side relative to the accommodation portion 71 (the side opposite to the cap assembly 42 when seen from the wiper assembly 41) and the cover 77 is opened from the right side (on the cap assembly 42 side when seen from the wiper assembly 41), it is possible to reduce or prevent damage to the cover 77 caused by the contact with the carriage 21.

The leaf spring 77B (see FIG. 4) is configured to come into contact with the replacement assembly 80 and hold the replacement assembly 80 from above. The leaf spring 77B is provided in a cantilevered manner, and an end portion thereof on the free end side comes into contact with the contact portion 83F of the replacement assembly 80. With the replacement assembly 80 being held through the leaf spring 77B, it is possible to reduce or prevent the damage to the cover 77 and the replacement assembly 80.

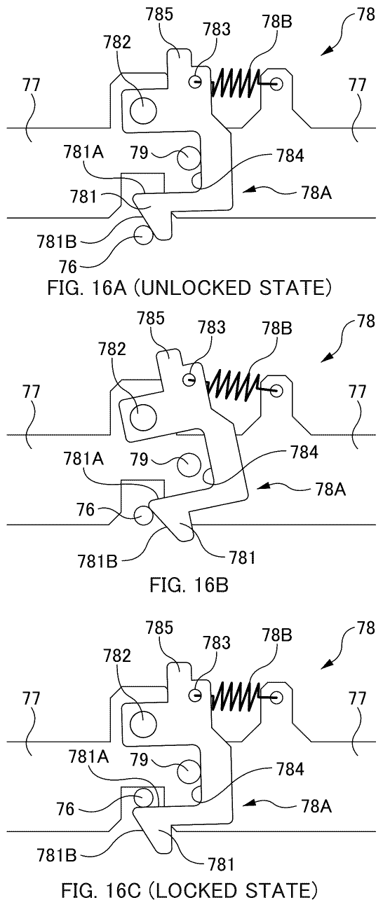

The locking mechanism 78 secures the cover 77 in a closed state. The locking mechanism 78 is provided on the side opposite to the hinge 77A. Here, the locking mechanism 78 is provided on the right side of the cover 77. The locking mechanism 78 is engaged with a locking portion 76 (see FIGS. 16A to 16C) that is provided on a right surface of the movable body 70 to secure the cover 77 in the closed state.

FIGS. 16A to 16C are explanatory views of the locking mechanism 78. FIG. 16A is an explanatory view of a state before the cover 77 is locked by the locking mechanism 78. FIG. 16B is an explanatory view of a situation where a hook 78A is rotated by the locking portion 76 of the movable body 70. FIG. 16C is an explanatory view of a state where the cover 77 is secured by the locking mechanism 78.

The locking mechanism 78 preferably includes the hook 78A and a spring 78B. The hook 78A is engageable with the locking portion 76 of the movable body 70. The hook 78A is rotatably supported by the cover 77. In the following description, the state where the hook 78A is engaged with the locking portion 76 as illustrated in FIG. 16A may be referred to as “unlocked state”, and the state where the hook 78A is disengaged from the locking portion 76 as illustrated in FIG. 16C may be referred to as “locked state”. In addition, a direction in which the hook 78A in the locked state rotates in a direction of being disengaged from the locking portion 76 (a counterclockwise direction in FIGS. 16A to 16C) may be referred to as “unlocking direction”, and a direction in which the hook 78A rotates in a direction opposite thereto (a clockwise direction in FIGS. 16A to 16C) may be referred to as “locking direction”.

The hook 78A preferably includes a claw portion 781, a rotational shaft 782, a biasing portion 783, a contact portion 784, and an operation portion 785. Note that the movable body 70 is provided with the locking portion 76, and the cover 77 is provided with a restriction portion 79.

The claw portion 781 is engageable with the locking portion 76 of the movable body 70. The claw portion 781 includes an engagement portion 781A and an inclined portion 781B. The engagement portion 781A is a portion to be engaged with the locking portion 76 of the movable body 70. With the engagement portion 781A being engaged with the locking portion 76, the cover 77 is secured in the closed state. The inclined portion 781B is contactable with the locking portion 76 of the movable body 70 to rotate the hook 78A in the unlocking direction (see FIG. 16B). The rotational shaft 782 is a pivot for rotation of the hook 78A. The biasing portion 783 is a portion to receive a force from the spring 78B. The biasing portion 783 receives, from the spring 78B, a force of rotating the hook 78A in the locking direction. The contact portion 784 is configured to come into contact with the restriction portion 79. With the contact portion 784 being brought into contact with the restriction portion 79, the rotation of the hook 78A in the locking direction is restricted (see FIGS. 16A and 16C). The operation portion 785 operates the hook 78A. A worker operates the operation portion 785, to rotate the hook 78A in the locked state in the unlocking direction to disengage the hook 78A from the locking portion 76.

The spring 78B biases the hook 78A with a force in the locking direction. One end of the spring 78B is coupled to the biasing portion 783 of the hook 78A, and the other end thereof is coupled to the cover 77. Here, the spring 78B is in a state of being stretched and deformed. However, the spring 78B may be in a state of being contracted and deformed, as long as the hook 78A can be biased with the force in the locking direction.

Note that the locking mechanism 78 does not have to include the spring 78B. For example, a configuration may be such that, instead of biasing the hook 78A with the force in the locking direction by using the force of the spring 78B, the hook 78A rotates in the locking direction by own weight of the hook 78A.

The hook 78A is preferably made of a sheet metal. Since the hook 78A is made of metal, it is possible to reduce or prevent the damage to the hook 78A, as compared to a case where the hook 78A is made of a resin. However, the locking mechanism 78 and the hook 78A are not limited to those made of metal, but may be made of a resin. For example, the locking mechanism 78 may be made of a resin configured to provide snap-fitting. As such, the configuration of the locking mechanism 78 is not limited to that illustrated in FIGS. 16A to 16C.

The replacement assembly 80 described above includes the sheet S, the supply roller 81, the winding roller 82, and the holding portion 83 to hold the supply roller 81 and the winding roller 82. In an example embodiment of the present disclosure, the holding portion 83 holds the supply roller 81 and the winding roller 82 to facilitate the work of accommodating the supply roller 81 and the winding roller 82 in the accommodation portion 71, in replacing the sheet S.

The holding portion 831 desirably holds the rotation shaft of the supply roller 81 and the rotation shaft of the winding roller 82 in parallel or substantially in parallel. This makes it possible to prevent the wrinkle from being formed in the sheet S or the sheet S from being transported unevenly.

The holding portion 83 includes the paired holding portions 831. The paired holding portions 831 desirably hold two ends of the supply roller 81 and two ends of the winding roller 82, respectively. This facilitates holding of the supply roller 81 and the winding roller 82 in parallel or substantially in parallel, as compared to a case where the supply roller 81 is held in the cantilevered manner, or a case where the winding roller 82 is held in the cantilevered manner.

The paired holding portions 831 preferably have the same shape. This makes it possible to easily configure the holding portion 83 that holds the rotation shaft of the supply roller 81 and the rotation shaft of the winding roller 82 in parallel or substantially in parallel.

The holding portion 83 includes the contact portion 83F that is to come in contact with the cover 77. This makes it possible to hold the replacement assembly 80 mounted to the liquid ejection apparatus 100, with the cover 77.

The replacement assembly 80 desirably includes the auxiliary roller 84 that is between the supply roller 81 and the winding roller 82, the auxiliary roller 84 being configured to come into contact with the surface of the sheet S. This makes it possible to reduce or prevent a change in the posture of the sheet S.

The auxiliary roller 84 desirably has the main shaft portion 84A, the main shaft portion having a diameter that gradually decreases toward the center portion thereof. This makes it possible to prevent the sheet S from being uneven in the width direction.

The brim portion 84B is desirably provided at each end of the main shaft portion 84A of the auxiliary roller 84. This makes it possible to prevent the sheet S from being uneven in the width direction.

The brim portion 84B of the auxiliary roller 84 desirably has the tapered surface. This makes it possible to further reduce or prevent the sheet S from being uneven in the width direction.

The winding roller 82 has one end provided with winding-side gear 82A configured to mesh with the drive-side gear provided to the winding motor 72. This makes it possible to transfer the rotational force of the winding motor 72 to the winding roller 82. Further, the supply roller 81 desirably has one end provided with the supply-side gear 81A configured to mesh with the driven gear. This makes it possible to apply the appropriate amount of the back tension to the sheet S.

The liquid ejection apparatus 100 described above preferably includes the head 10, the movable body 70, and the applicator 62. The head 10 includes the nozzle surface 10A in which the multiple nozzle rows 11 are positioned at the predetermined intervals (see FIG. 3). The movable body 70 is configured to accommodate the sheet S to wipe the nozzle surface 10A, the movable body 70 being movable with respect to the head 10. The applicator 62 applies the cleaning solution to the sheet S, and includes the multiple ejection ports 62B configured to eject the cleaning solution toward the sheet S. In an example embodiment of the present disclosure, the multiple ejection ports 62B are positioned at the intervals (the predetermined intervals) that are the same as those of the nozzle rows 11 (see FIG. 9). This makes it possible to reduce or minimize the amount of consumption of the cleaning solution.

The applicator 62 preferably includes the flow paths 62C, through which the cleaning solution is to be passed from the supply port 62A to the ejection ports 62B, and the flow paths 62C are provided with the branch portion 62D such that the lengths of the flow paths 62C to the respective ejection ports 62B are to be equal. This makes it possible to equalize the amounts of ejection of the cleaning solution that are ejected from the respective ejection ports to reduce the amount of consumption of the cleaning solution.

The movable body 70 is preferably provided with the supply roller 81, the winding roller 82, and the pressing roller 73 configured to press the sheet S against the head 10. The applicator 62 in an example embodiment of the present disclosure applies the cleaning solution to the sheet S in the region between the supply roller 81 and the pressing roller 73. This makes it possible to apply the cleaning solution to the unused sheet S.

The auxiliary roller 84 to come into contact with the surface of the sheet S is provided between the supply roller 81 and the pressing roller 73. This makes it possible to maintain the inclination angle of the sheet S to be constant at the position at which the cleaning solution is applied.

The movable body 70 is configured such that the replacement assembly 80 is attachable/detachable thereto/therefrom. This makes it possible to replace the sheet S.

The replacement assembly 80 preferably includes the holding portion 83 that holds the supply roller 81 and the winding roller 82. This facilitates the work of accommodating the supply roller 81 and the winding roller 82 in the movable body 70, in replacing the sheet S.

The liquid ejection apparatus 100 preferably includes the winding motor 72 configured to rotate the winding roller 82, the rotary encoder 75 configured to detect the amount of rotation of the supply roller 81, and the controller 50 configured or programmed to control driving of the winding motor 72, based on the amount of use of the sheet S (for example, the number of the wipes) and the detection result of the rotary encoder 75. This makes it possible to transport the sheet S by the predetermined amount, even when the amount of supply of the sheet S with respect to the amount of rotation of the supply roller 81 changes.

The controller 50 preferably is configured or programmed to detect an abnormality, based on the detection result of the rotary encoder 75 during the driving of the winding motor 72. This makes it possible to detect an abnormality of the apparatus.

The rotary encoder 75 is desirably provided to the rotational shaft of the driven gear (driven shaft) configured to rotate in accordance with the rotation of the supply roller 81. With the provision of the driven gear configured to rotate in accordance with the rotation of the supply roller 81, it is possible to apply the appropriate amount of the back tension to the sheet S. In addition, with the adjustment of the number of the teeth of the driven gear, it is possible to adjust detection accuracy of the rotary encoder 75.

The movable body 70 includes the cover 77 that is openable/closable with the rotational shaft extending along a direction (the front-rear direction; the first direction) that intersects the direction of scanning, and the rotational shaft is closer to the printing region (the region where the head 10 ejects the liquid onto the medium M) than the accommodation portion 71. This makes it possible to reduce or prevent damage to the cover 77.

Further, when the carriage 21 is positioned at the home position that is on the side opposite to the printing region (the region where the head 10 ejects the liquid onto the medium M), the carriage 21 is desirably above the end portion of the cover 77 to prevent opening of the cover 77. This causes the carriage 21 to be positioned at the printing region when the cover 77 is opened to reduce or prevent the damage to the cover 77, even in the case where the carriage 21 unexpectedly moves and comes into contact with the cover 77 while the cover 77 is opened.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A replacement assembly attachable/detachable to/from a liquid ejection apparatus including a head that is configured to eject a liquid, the replacement assembly comprising:
a sheet to wipe a nozzle surface of the head;
a supply roller configured to supply the sheet;
a winding roller configured to wind the sheet; and
a holding portion to hold the supply roller and the winding roller.

2. The replacement assembly according to claim 1, wherein the holding portion is configured to hold a rotation shaft of the supply roller and a rotation shaft of the winding roller in parallel or substantially in parallel.

3. The replacement assembly according to claim 1, wherein the holding portion includes a pair of holding portions to hold two ends of the supply roller and two ends of the winding roller, respectively.

4. The replacement assembly according to claim 3, wherein the pair of holding portions have a same shape.

5. The replacement assembly according to claim 1, wherein the holding portion includes a contact portion that is contactable with a cover of the liquid ejection apparatus.

6. The replacement assembly according to claim 1, further comprising:
an auxiliary roller between the supply roller and the winding roller, the auxiliary roller being contactable with a surface of the sheet.

7. The replacement assembly according to claim 6, wherein when the replacement assembly is mounted to the liquid ejection apparatus, a lower edge of the auxiliary roller is positioned below a tangent line contacting an upper edge of the supply roller and an upper edge of a pressing roller configured to press the sheet against the head.

8. The replacement assembly according to claim 6, wherein the auxiliary roller includes a main shaft portion with a diameter that decreases toward a center portion thereof.

9. The replacement assembly according to claim 6, wherein the auxiliary roller includes:
a main shaft portion that is to contactable with the sheet; and
a brim portion provided to each end of the main shaft portion.

10. The replacement assembly according to claim 9, wherein the brim portion includes a tapered surface.

11. The replacement assembly according to claim 1, wherein
the winding roller includes one end provided with a winding-side gear configured to mesh with a drive-side gear provided to a winding motor; and
the supply roller includes one end provided with a supply-side gear configured to mesh with a driven gear.

12. A liquid ejection apparatus, to/from which the replacement assembly according to claim 1 is attachable/detachable, the liquid ejection apparatus comprising:
a head that includes a nozzle surface in which a plurality of nozzle rows are positioned at predetermined intervals;
a movable body to/from which the replacement assembly is attachable/detachable, the movable body being movable with respect to the head; and
an applicator configured to apply a cleaning solution to the sheet; wherein
the applicator includes a plurality of ejection ports configured to eject the cleaning solution toward the sheet; and
the plurality of ejection ports are positioned at the predetermined intervals.

13. The liquid ejection apparatus according to claim 12, wherein
the applicator includes flow paths through which the cleaning solution supplied from a supply port is to be passed to the ejection ports; and
the flow paths are provided with a branch portion where a flow of the cleaning solution branches off such that lengths of the flow paths from the supply port to the ejection ports are equal or substantially equal.

14. The liquid ejection apparatus according to claim 12, wherein
the movable body is provided with a pressing roller between the supply roller and the winding roller, the pressing roller being configured to press the sheet against the head; and
the applicator applies the cleaning solution to the sheet in a region between the supply roller and the pressing roller.

15. The liquid ejection apparatus according to claim 14, wherein
an auxiliary roller contactable with a surface of the sheet is provided between the supply roller and the pressing roller; and
the applicator is configured to apply the cleaning solution to the sheet in the region between the auxiliary roller and the pressing roller.

16. The liquid ejection apparatus according to claim 12, further comprising:
a winding motor configured to rotate the winding roller to feed the sheet from the supply roller to the winding roller;
a rotary encoder configured to detect an amount of rotation of the supply roller; and
a controller configured or programmed to control driving of the winding motor based on an amount of use of the sheet and a detection result of the rotary encoder.

17. The liquid ejection apparatus according to claim 16, wherein the controller is configured or programmed to detect an abnormality, based on the detection result of the rotary encoder during the driving of the winding motor.

18. The liquid ejection apparatus according to claim 16, wherein the rotary encoder is provided to a driven shaft configured to rotate in association with rotation of the supply roller.

19. The liquid ejection apparatus according to claim 12, wherein
the head is movable in a direction of scanning;
the movable body includes:
an accommodation portion to accommodate the sheet in a replaceable manner; and
a cover that is openable/closable with a rotational shaft extending along a direction that intersects the direction of scanning; and
the rotational shaft is closer to a region where the head ejects the liquid on to a medium than the accommodation portion.

20. The liquid ejection apparatus according to claim 19, wherein when a carriage to which the head is mounted is positioned at a home position that is on a side opposite to the region where the head ejects the liquid onto the medium, the carriage is above an end portion of the cover to prevent opening of the cover.
